(19) United States
(12) Patent Application Publication
(10) Pub. No.: US 2013/0090151 A1
(43) Pub. Date: Apr. 11, 2013

(54) METHOD AND APPARATUS FOR ADVANCED MOTION DETECTION IN WIRELESS COMMUNICATIONS SYSTEMS

(71) Applicants: Francis Ming-Meng Ngai, Louisville, CO (US); Carlos Puig, Santa Clara, CA (US); Arvind Swaminathan, San Diego, CA (US)

(72) Inventors: Francis Ming-Meng Ngai, Louisville, CO (US); Carlos Puig, Santa Clara, CA (US); Arvind Swaminathan, San Diego, CA (US)

(73) Assignee: QUALCOMM INCORPORATED, San Diego, CA (US)

(21) Appl. No.: 13/563,629

(22) Filed: Jul. 31, 2012

Related U.S. Application Data
(60) Provisional application No. 61/544,041, filed on Oct. 6, 2011.

(51) Int. Cl. H04W 88/02

(52) U.S. Cl. 455/574

(57) ABSTRACT

Advanced Motion Detection in Wireless Communication Systems processes accelerometer or other sensor input data to distinguish between random in-place movements and actual start of motion that could produce a change in the user's location by filtering unsustained random motion. Random in-place motion such as table banging, knee jiggling, vibration, etc. are filtered out from Stationary and Non-Stationary motion state determinations. The process utilizes data from motion sensors or any accelerometer standard in all smart mobile devices and any mobile device that has automatic portrait-landscape switching (screen rotation). A state machine processes sensor or other input to produce a filtered Stationary or Non-Stationary output movement state unaffected by transient motion or rest periods. A sensor processing subsystem (SPS), or other low power processor for processing sensor or other input may be implemented to reduce power consumption and processing overhead while, for example, a modem processor or other high power processor is in a sleep mode.

### CLAIM OF PRIORITY UNDER 35 U.S.C. §119

The present Application for Patent claims priority to Provisional Application No. 61/544,041 entitled METHOD AND APPARATUS FOR OPTIMIZED REACQUISITION OF WIRELESS COMMUNICATIONS SYSTEMS filed Oct. 6, 2011, and assigned to the assignee hereof and hereby expressly incorporated by reference herein.

### REFERENCE TO CO-PENDING APPLICATIONS FOR PATENT

The present Application for Patent is related to the following co-pending U.S. patent application “Method and Apparatus For Optimized Reacquisition of Wireless Communications Systems” by Ngai et al., having Attorney Docket No. 111049U1, filed concurrently herewith, assigned to the assignee hereof, and expressly incorporated by reference herein.

### BACKGROUND

1. Field

The present invention relates generally to wireless communications, and more specifically to techniques for optimizing motion detection in wireless communications systems.

2. Background

Wireless communication systems are widely deployed to provide various types of communication and to communicate information regardless of where a user is located (e.g., inside or outside a structure) or whether a user is stationary or moving (e.g., in a moving vehicle, walking). For example, voice, data, video and so forth can be sent both to and from mobile devices through wireless communication systems. A typical wireless communication system, or network, can provide multiple users access to one or more shared resources. A system can use a variety of multiple access techniques such as Frequency Division Multiplexing (FDM), Time Division Multiplexing (TDM), Code Division Multiplexing (CDM), Orthogonal Frequency Division Multiplexing (OFDM), and others. These systems may comprise technologies such as 3rd Generation Partnership Project (3GPP) and 3rd Generation Partnership Project 2 (3GPP2) networks having W-CDMA (Wideband Code Division Multiple Access) air interfaces, Global System for Mobile Communications (GSM), or other network technologies such as Universal Mobile Telecommunication System (UMTS) Terrestrial Radio Access (UTRA). Mobile devices support Single carrier (1×) radio transmission technology, CDMA2000 EVDO, CDMA2000 1×RTT, GSM and WCDMA.

Mobile devices have evolved to support unlimited user applications and service features. Many user applications and service features require mobile device movement status information for optimal operation. For example, navigation applications and Out of Service (OOS) features (when signal coverage is lost due to user movement, signal blockage, or other outages) depend on the movement status of the mobile device. Traditional movement status sensing does not distinguish between random in-place movements and actual start of motion that could produce a change in the user's location. Random in-place motion such as table banging, knee jiggling, vibration, etc. result in Non-Stationary movement state reporting when such motion is neither sustained by the user nor changes the user location. Conversely, traditional movement status sensing does not distinguish between short pauses in movement and actual cessation of motion that could have produced a change in the user's location. For example, a user may stop walking and hold the device steady for a brief time to read a text message that just arrived, before continuing to walk. There is therefore a need in the art to optimize movement state reporting in mobile devices to filter random and/or unsustainable movements and brief movement pauses from motion status determinations.

### BRIEF DESCRIPTION OF THE DRAWINGS

FIG. 1 is a diagram illustrating an example of a wireless network in which Advanced Motion Detection in Wireless Communications Systems can be used;

FIG. 2 is an exemplary state diagram illustrating Advanced Motion Detection in Wireless Communications Systems operation;

FIG. 3 is an exemplary flowchart illustrating Advanced Motion Detection in Wireless Communications Systems methodology; and

FIG. 4 is a block diagram illustrating an exemplary wireless device capable of Advanced Motion Detection in Wireless Communications Systems.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

The terms “mobile device”, “wireless device” and “user equipment” (UE) as used herein refer to and may contain some or all of the functionality of a system, subscriber unit, subscriber station, mobile station, mobile, wireless terminal, node, device, remote station, remote terminal, access terminal, user terminal, terminal, wireless communication device, wireless communication apparatus, user agent, user device, or user equipment (UE). A mobile device can be a cellular telephone, a cordless telephone, a Session Initiation Protocol (SIP) phone, a smart phone, a wireless local loop (WLL) station, a personal digital assistant (PDA), a laptop, a tablet, a handheld communication device, a handheld computing device, a satellite radio, a wireless modem card and/or another processing device for communicating over a wireless system. Moreover, various aspects are described herein in connection with a base station. A base station may be utilized for communicating with wireless terminal(s) and can also be called, and may contain some or all of the functionality of, an access point, node, Node B, e-NodeB, e-NB, or some other network entity.

Substantial improvements in wireless network performance and reduced power consumption in wireless devices are realized using improved mobile device movement state information. Stationary and Non-Stationary movement states determine scanning patterns, power modes and sleep durations for a variety of user applications and network services.

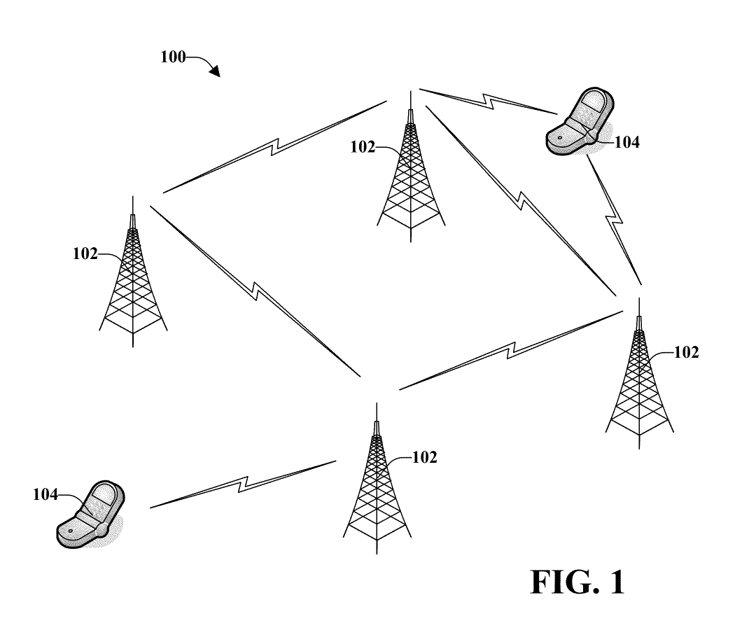

FIG. 1 illustrates a wireless communication system 100 in accordance with various aspects presented herein. System 100 can comprise one or more base stations 102 in one or more sectors that receive, transmit, repeat, or otherwise exchange wireless communication signals with each other and/or to one or more mobile devices 104. Each base station 102 can comprise multiple transmitter chains and receiver chains (e.g., one for each transmit and receive antenna), each of which can in turn comprise a plurality of components associated with signal transmission and reception (e.g., processors, modulators, multiplexers, demodulators, demultiplexers, antennas, and so forth). Each mobile device 104 can comprise one or more transmitter chains and receiver chains, which can be utilized for a multiple input multiple output (MIMO) system. Each transmitter and receiver chain can comprise a plurality of components associated with signal transmission and reception (e.g., processors, modulators, multiplexers, demodulators, demultiplexers, antennas, and so on), as will be appreciated by one skilled in the art. One or more base stations 102 can be associated with a home network or with a roaming network, depending on the communication environment. Each mobile device 104 can be configured for advanced motion detection as detailed in the following figures.

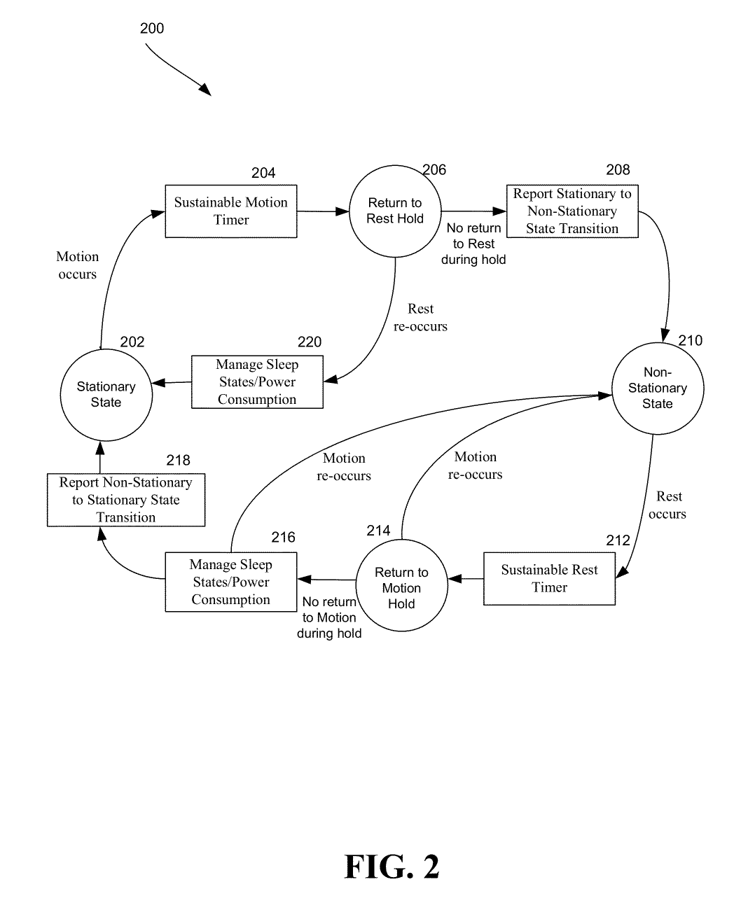

FIG. 2 is an exemplary state machine illustrating Advanced Motion Detection in Wireless Communications Systems operation 200. A state machine processes sensor or other input comprising Rest and Motion information. The sensor or other input information is filtered to produce a Stationary or Non-Stationary output movement state. A sensor processing subsystem (SPS), or other low power processor for processing sensor or other input may be implemented to reduce power consumption and processing overhead while, for example, a modem processor or other high power processor is in a sleep mode. Conversely, Advanced Motion Detection in Wireless Communications Systems may be implemented on a modem processor having an attached accelerometer, or on a separate processor for handling the sensor input that communicates with the modem processor via a signaling method. A separate processor may be an applications processor, internal or external microprocessor, a sensor processing subsystem (SPS), etc. Advanced Motion Detection prevents short duration motion sensor input (i.e. tapping, turning, jiggling of the mobile device, etc.) from causing an unsustainable, short-lived movement state transition from Stationary to Non-Stationary. Advanced Motion Detection also excludes short at rest sensor input (i.e. pausing walking to read a text message, etc.) from causing an unsustainable, short-lived movement state transition from Non-Stationary to Stationary. In an exemplary embodiment, Advanced Motion Detection state information is utilized for optimizing reacquisition of wireless communication systems during Out of Service scenarios detailed in co-pending U.S. patent application METHOD AND APPARATUS FOR OPTIMIZED REACQUISITION OF WIRELESS COMMUNICATION SYSTEMS, having Attorney Docket No. 111049U1, filed concurrently herewith, assigned to the assignee hereof, and expressly incorporated by reference herein.

Advanced Motion Detection in Wireless Communication Systems processes accelerometer or other sensor input data to generate a current Rest or Motion status. The Rest or Motion status is filtered to distinguish between random in-place movements and actual start of motion that could produce a change in the user's location, and to distinguish short motion pauses from actual cessation of motion that could have produced a change in the user's location. The process uses sensor motion status (Rest or Motion) information to determine the device movement state (Stationary or Non-Stationary). Random in-place motion such as table banging, knee jiggling, vibration, etc. is filtered out from movement state determinations. Brief pauses such as stopping to quickly read a text message are also filtered out from movement state determinations. The process utilizes data available from motion sensors or any accelerometer standard in all smart mobile devices and any mobile device that has automatic portrait-landscape switching (screen rotation). Filters for sustained motion or sustained rest are applied before changing a movement state so that a movement state does not respond to unsustained random motion, or unsustained brief pauses.

When Motion status occurs in Stationary State (202), a Sustainable Motion timer is started (204) for a Return to Rest hold period (206). If the Motion status of the mobile device continues through the Return to Rest hold period, a state transition from a Stationary state to a Non-Stationary state is reported (208) and a transition to a Non-Stationary state is completed (210). If the Motion status is spurious and/or transient, and does not continue through the Return to Rest hold period, power control is managed (220) by keeping high power processors and peripherals asleep until actual sustained motion lasting longer than the Return to Rest hold period has been determined while a Stationary (202) state is maintained.

When Rest status occurs in a Non-Stationary state (210), a Sustainable Rest timer is started (212) for a Return to Motion hold period (214). If the Rest status of the mobile device continues through the Return to Motion hold period (214), power control is managed (216) by putting high powered processors and peripherals in deep sleep or power saving modes. A state transition from a Non-Stationary state to a Stationary state is reported (218) and a transition to a Stationary state is completed (202). If the Rest status is spurious and/or transient, and does not continue through the Return to Motion hold period until actual sustained rest lasting longer than the Return to Motion hold period has been detected, or if a Motion status re-occurs during a power control mode change, a Non-Stationary (210) state is maintained.

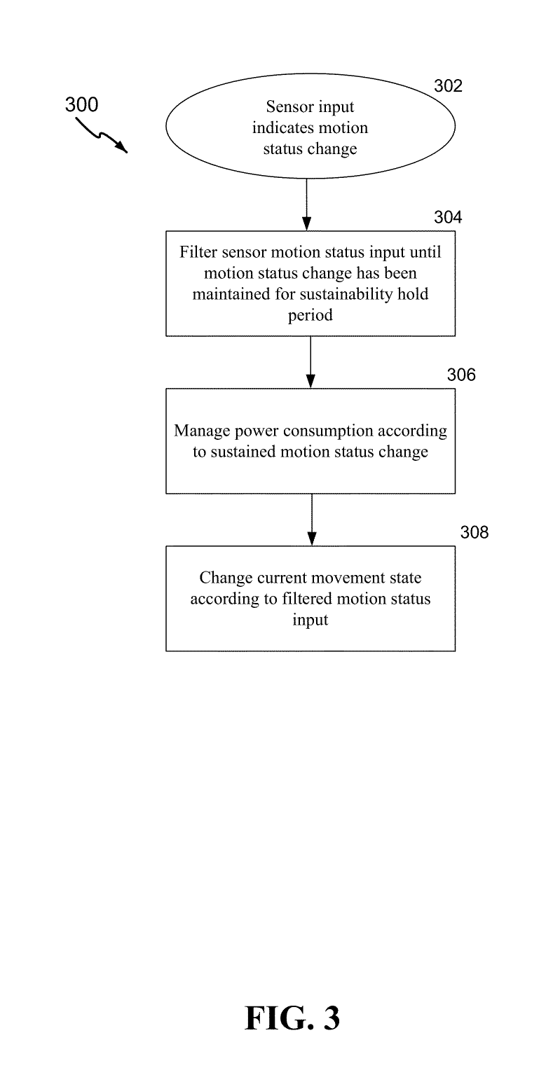

FIG. 3 is an exemplary flowchart illustrating Advanced Motion Detection in Wireless Communications Systems methodology 300. Control flow begins in step 302 when mobile device motion sensors indicate a motion status change is occurring. A motion status may change from Rest to Motion or vice versa. Control flow proceeds to step 304.

In step 304, sensor input is filtered until the Rest or Motion status change has been maintained for a sustainability hold period before a new current Stationary or Non-stationary movement state is determined In one embodiment, the hold period is 10-20 seconds. Control flow proceeds to step 306.

In step 306, power control is managed according to the sustained movement state. High powered processors and radios scanning channels are not powered unless scanning is necessary because there is a possibility that the user has actually changed position. In the normal power mode, the sensor processor subsystem is using the accelerometer or other motion sensor to see if there is motion and making a Motion/Rest status decision. In one embodiment, the sensor processing subsystem takes a very short look to see if Motion or Rest is occurring, for a fraction of a second. If at Rest, a sensor processing subsystem may be shut down and a timer may be set to wake up again 10 or 20 seconds later, for example, and then repeat a Motion/Rest decision process. It is a duty cycled process, where the processors go back to sleep if Motion is not detected. The sensor processing subsystem is awake, for example, for approximately 5% of the time and is off the remaining 95% of the time, resulting in extremely low power state needed by the low power states. Other embodiments may use different sensor processing duty cycle parameters. Control flow proceeds to step 308.

In step 308, a current movement state is changed according to the filtered motion status input.

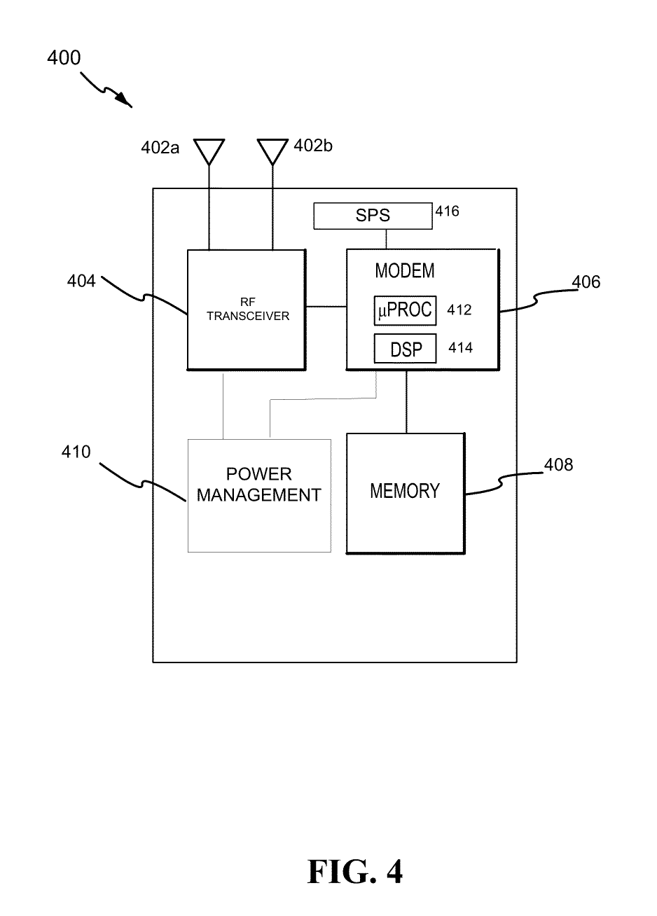

FIG. 4 is a block diagram illustrating an exemplary wireless device capable of Advanced

Motion Detection in Wireless Communications Systems. Wireless device 400 comprises a wireless communication transceiver 404 and associated antennas 402a, 402b capable of sending and receiving wireless communication signals. Modem 406 comprises the appropriate microprocessor(s) 412, digital signal processor(s) 414 and other suitable hardware, such as a correlator bank, for processing signals. Power management 410 controls power for various components of wireless device 400. Memory 408 is coupled to modem 404 as necessary for implementing various modem processes and functionality for single path detection and equalizer optimization. Wireless device 400 may comprise an appropriate user interface with alphanumeric keypad, display, microphone, speaker, and other necessary components (not shown). It will be appreciated by those skilled in the art that wireless device 400 may comprise a variety of components not shown.

The methodology for Advanced Motion Detection in Wireless Communications Systems described herein may be implemented by suitable instructions operating on the microprocessor 412, optionally the SPS or other processor 416 and memory 408 of wireless device 400, but is certainly not limited to such an implementation and may alternatively be implemented in hardware circuitry. The microprocessor 412 is connected to power management 410 and memory 408 having code or instructions directing the microprocessor 412 to perform Advanced Motion Detection in Wireless Communications Systems. Memory 408 may comprise instructions for performing Advanced Motion Detection in Wireless Communications Systems. The memory 408 may include RAM memory, flash memory, ROM memory, EPROM memory, EEPROM memory, registers, a hard disk, a removable disk, a CD-ROM, or any other form of storage medium or computer readable media known in the art. In an exemplary aspect, the control processor 412 executes instructions stored in memory 408 according to the steps of FIGS. 2-3 to perform Advanced Motion Detection in Wireless Communications Systems. An advanced motion detection process may operate independently, on a dedicated low power DSPS, or other processor 416.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for detecting movement of wireless communications devices comprising:
filtering sensor input until a motion status change has been sustained for a sustainability hold period;
managing power consumption according to the sustained motion status change; and
changing a current movement state to the sustained motion status according to the filtered sensor input.

2. The method of claim 1 wherein a current movement state comprises a Non-Stationary state.

3. The method of claim 1 wherein a current movement state comprises a Stationary state.

4. The method of claim 1 wherein managing the power consumption comprises implementing low power modes for processors during a Stationary state.

5. The method of claim 4 wherein the low power mode is implemented on a high duty cycle.

6. A wireless device comprising:
a wireless communications transceiver and associated antenna(s) capable of sending and receiving wireless communications signals;
a modem coupled to the transceiver comprising processor(s) for processing signals and executing code stored in a memory;
a power management unit coupled to the modem and the transceiver for measuring and controlling processor and radio power consumption; and
a memory coupled to the modem for storing instructions for filtering sensor input until a motion status change has been sustained for a sustainability hold period, managing power consumption according to the sustained motion status change, and changing a current movement state to the sustained motion status according to the filtered sensor input.

7. The wireless device of claim 5 wherein a current movement state comprises a Non-Stationary state.

8. The wireless device of claim 5 wherein a current movement state comprises a Stationary state.

9. The wireless device of claim 5 wherein managing the power consumption comprises implementing low power modes for processors during a Stationary state.

10. The wireless device of claim 9 wherein the low power mode is implemented on a high duty cycle.

11. A non-transitory computer readable medium having instructions stored thereon to cause a processor in a wireless device to:
filter sensor input until a motion status change has been sustained for a sustainability hold period;
manage power consumption according to the sustained motion status change; and
change a current movement state to the sustained motion status according to the filtered sensor input.

12. The non-transitory computer readable medium of claim 11 wherein a current movement state comprises a Non-Stationary state.

13. The non-transitory computer readable medium of claim 11 wherein a current movement state comprises a Stationary state.

14. The non-transitory computer readable medium of claim 11 wherein managing the power consumption comprises implementing low power modes for processors during a Stationary state.

15. The non-transitory computer readable medium of claim 14 wherein the low power mode is implemented on a high duty cycle.

16. A means for detecting movement of wireless communications devices comprising:
means for filtering sensor input until a motion status change has been sustained for a sustainability hold period;
means for managing power consumption according to the sustained motion status change; and
means for changing a current movement state to the sustained motion status according to the filtered sensor input.

17. The means of claim 16 wherein a current movement state comprises a Non-Stationary state.

18. The means of claim 16 wherein a current movement state comprises a Stationary state.

19. The means of claim 16 wherein managing the power consumption comprises implementing low power modes for processors during a Stationary state.

20. The means of claim 19 wherein the low power mode is implemented on a high duty cycle.
